(19) United States
(12) Patent Application Publication
(10) Pub. No.: US 2012/0026410 A1
(43) Pub. Date: Feb. 2, 2012

(54) INFORMATION PROCESSING APPARATUS AND CONTROL METHOD USED FOR THE SAME

(75) Inventor: Tomotaka Ida, Kumagaya-shi (JP)

(73) Assignee: KABUSHIKI KAISHA TOSHIBA, Tokyo (JP)

(21) Appl. No.: 13/089,021

(22) Filed: Apr. 18, 2011

(30) Foreign Application Priority Data
Jul. 30, 2010 (JP) 2010-172049

(51) Int. Cl. H04N 5/44

(52) U.S. Cl. 348/734; 348/E05.096

(57) ABSTRACT

According to one embodiment, an information processing apparatus includes a receiver, a connection terminal, a generator and a change module. The receiver is configured to receive operating information wirelessly send from a remote controller. The connection terminal is configured to input and output operating information through a wire. The generator is configured to generate the operating information through the connection terminal. The change module is configured to selectively set the following states. One is a state of inputting operating information through the connection terminal. The other is a state of outputting at least one of operating information received by the receiver and operating information output from the generator through the connection terminal.

### CROSS-REFERENCE TO RELATED APPLICATIONS

This application is based upon and claims the benefit of priority from Japanese Patent Application No. 2010-172049, filed Jul. 30, 2010; the entire contents of which are incorporated herein by reference.

### FIELD

Embodiments described herein relate generally to a wirelessly remotely controllable information processing apparatus using a remote controller, and to a control method used for the same.

### BACKGROUND

As is well known, for example, a generally domestic audiovisual (AV) apparatus such as a digital television broadcasting receiver is given as a typical example of an information processing apparatus. In such an audiovisual apparatus, when the user operates a remote controller, the apparatus receives wirelessly sent operating information (also referred to herein as a “command”). In this way, the apparatus is remotely controllable to various operating states and a stopped state.

In recent years, the diversification of an operating mode has been facilitated. For example, one AV apparatus is not only operated by a remote controller corresponding thereto, but also a plurality of AV apparatuses is connected by wire so that operating information is sendable; in this way, a specified AV apparatus operates other AV apparatus. Moreover, other AV apparatus is operated by operating information sent from a remote controller to a specified AV apparatus.

However, the foregoing technique of performing the diversification of an operating form with respect to several AV apparatuses is in a developing state yet. For this reason, various improvements must be achieved over the details. In particular, most AV apparatuses currently have a tendency to be miniaturized except a display screen; therefore, it is deeply desired to achieve development capable of sufficiently satisfying the foregoing tendency.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing one example of the configuration of a signal processing system of a digital television broadcasting receiver according to one embodiment;

FIG. 2 is a view showing one example of the appearance of a remote controller used for a digital television broadcasting receiver according to one embodiment;

FIG. 3 is a view to explain one example of a setting menu screen displayed on a digital television broadcasting receiver according to one embodiment;

FIG. 4 is a view to explain one example of an operating mode of operating a digital television broadcasting receiver according to one embodiment using a remote controller;

FIG. 5 is a view to explain one example of an operating mode of operating a digital television broadcasting receiver according to one embodiment using an external audiovisual (AV) apparatus;

FIGS. 6A and 6B are views to explain one example of an operating mode of operating an external audiovisual (AV) apparatus using a remote controller of a digital television broadcasting receiver according to one embodiment;

FIGS. 7A and 7B are views to explain one example of an operating mode of operating an external audiovisual (AV) apparatus using a digital television broadcasting receiver according to one embodiment; and

FIG. 8 is a view to explain one example of an operating information select menu screen displayed on a digital television broadcasting receiver according to one embodiment.

### DETAILED DESCRIPTION

Various embodiments will be described hereinafter with reference to the accompanying drawings. In general, according to one embodiment, an information processing apparatus comprises a receiver, a connection terminal, a generator and a change module. The receiver is configured to receive operating information wirelessly send from a remote controller. The connection terminal is configured to input and output operating information through a wire. The generator is configured to generate the operating information through the connection terminal. The change module is configured to selectively set the following states. One is a state of inputting operating information through the connection terminal. The other is a state of outputting at least one of operating information received by the receiver and operating information output from the generator through the connection terminal.

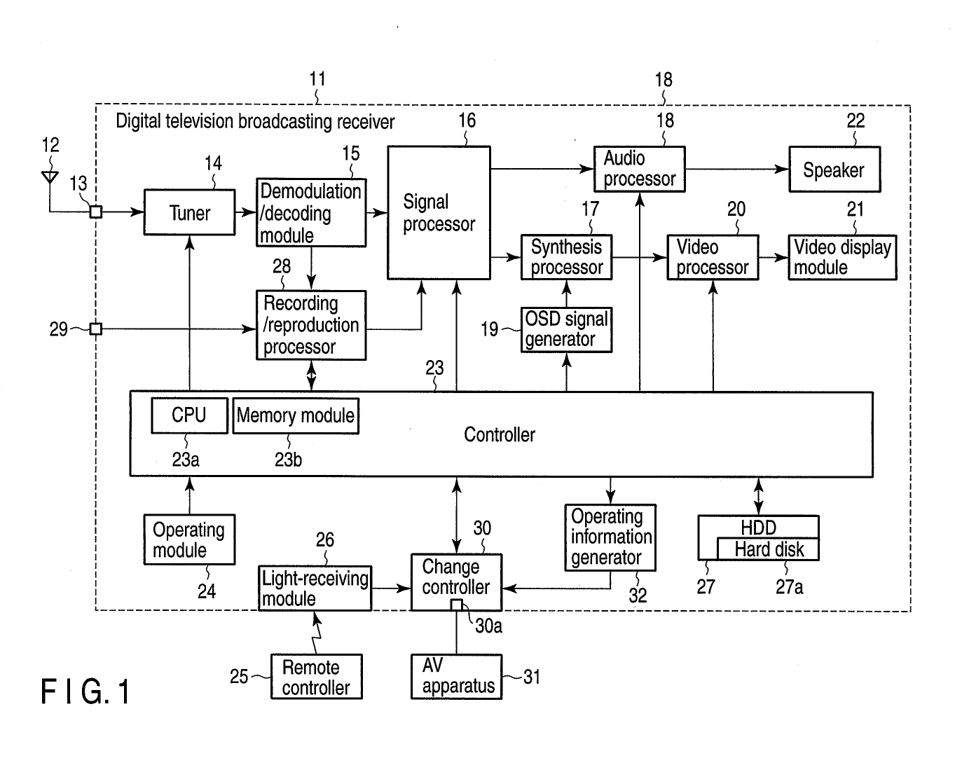

FIG. 1 is a block diagram schematically showing the configuration of a signal processing system of an audiovisual (AV) apparatus, that is, a digital television broadcasting receiver 11 given as on example of an information processing apparatus described in this embodiment.

Specifically, a digital television broadcasting signal received by an antenna 12 is supplied to a tuner 14 through an input terminal 13, and thereby, a desired channel broadcasting signal is tuned. The broadcasting signal tuned by the tuner 14 is supplied to a demodulation/decoding module 15 so that it is restored to digital video signal and audio signal, and thereafter, output to a signal processor 16.

The signal processor 16 carries out predetermined digital signal processing with respect to a digital video signal and audio signal supplied from the demodulation/decoding module 15. Then, the signal processor 16 outputs a digital video signal to a synthesis processing module 17 while outputting a digital audio signal to an audio processor 18.

The synthesis processing module 17 overlays an on-screen display (OSD) signal generated by an OSD signal generator 19 on the digital video signal, and then, outputs the signal. The digital video signal output from the synthesis processing module 17 is supplied to a video processor 20.

The video processor 20 converts an input digital video signal to a format, which is displayable by an after-stage flat video display module 21 having a liquid crystal display panel. Then, a display video signal output from the video processor 20 is supplied to the video display module 21 so that an image is displayed.

The audio processor 18 converts an input digital audio signal to an analog audio signal having a format which is reproducible by an after-stage speaker 22. The analog audio signal output from the audio processor 18 is supplied to the speaker 22 so that audio is reproduced.

In the digital television broadcasting receiver 11, all operations including the foregoing various receiving operation are collectively controlled by a controller 23. The controller 23 has a built-in central processing unit (CPU) 23a. The controller 23 receives operating information from an operating module 24, which is installed in a main body of the digital television broadcasting receiver 11 or receives operating information, which is sent from the remote controller 25 and received by a light-receiving module 26. In this way, the controller 23 controls various components so that the operating content is reflected.

In this case, the controller 23 uses a memory module 23b. The memory module 23b mainly has a read-only memory (ROM) stored with control programs executed by the CPU 23a, a random access memory (RAM) for providing a work area to the CPU 23a, and a nonvolatile memory stored with various setting information and control information.

Moreover, the controller 23 is connected with a hard disk drive (HDD) 27. The controller 23 performs the following control based on the operation of the operating module 24 and the remote controller by the user. According to the control, a recording/reproduction module 28 codes digital video signal and audio signal obtained from the foregoing demodulation/decoding module 15 to convert these signals to a predetermined recording format. Thereafter, the controller 23 supplies the converted signal to the HDD 27 to record it in a hard disk 27a.

Moreover, the controller 23 performs the following control based on the operation of the operating module 24 and the remote controller by the user. According to the control, the HDD 27 reads digital video signal and audio signal from the hard disk 27a, and then the foregoing recording/reproduction module 28 decodes these signals. Thereafter, the controller 23 supplies these signals to the signal processor 16 so that the foregoing video display and audio reproduction are performed.

Moreover, the foregoing digital television broadcasting receiver 11 is connected with an input terminal 29. The input terminal 29 directly inputs digital video signal and audio signal externally from the receiver 11. The digital video signal and audio signal input through the input terminal 29 are supplied to the recording/reproduction processor 28 based on the control of the controller 23 in accordance with the operation of the operating module 24 and the remote controller by the user. Thereafter, these signals are supplied to the signal processor 16 so that the foregoing video display and audio reproduction are performed.

The digital video signal and audio signal input through the input terminal 29 are supplied to the recording/reproduction processor 28 based on the control of the controller 23 in accordance with the operation of the operating module 24 and the remote controller by the user. Thereafter, these signals are further recorded and reproduced with respect to the hard disk 27a by means of the HDD 27.

The foregoing controller 23 is connected with a change controller 30. The change controller 30 includes an external connection terminal 30a. For example, the change controller 30 is connected by wire with other audiovisual (AV) apparatus such as a personal computer (PC) and an optical disk recording/reproduction apparatus. In this way, operating information is capable of being transmitted.

Specifically, the change controller 30 selectively changes a mode to the following modes based on the control of the controller 23 in accordance with the operation of the operating module 24 and the remote controller 25 by the user. One is an input mode of using the external connection terminal 30a as an operating information input terminal. The other is an output mode of using the external connection terminal 30a as an operating information output terminal.

Namely, when an operating information output terminal of the audiovisual (AV) apparatus 31 is connected, the external connection terminal 30a sets a mode to an input mode for inputting operating information output the AV apparatus 31. Moreover, when an operating information input terminal of the audiovisual (AV) apparatus 31 is connected, the external connection terminal 30a sets a mode to an output mode for outputting operating information to be input to the AV apparatus 31.

Although the detailed explanation will be described later, the change controller 30 is operated to unconditionally supply operating information from the light-receiving module 26 when operating information sent from the remote controller 25 and received by the light-receiving module 26 is supplied. In this case, the change controller 30 performs the foregoing operation even if the mode is set to any of the input and output modes. In this way, the controller 23 receives operating information sent from the remote controller 25, and then, controls various components so that the operating content is reflected.

When the input mode is set, the foregoing change controller 30 is operated to supply operating information supplied from an external AV apparatus 31 to the controller 23. In this way, the controller 23 receives operating information supplied from the external AV apparatus 31, and then, controls various components so that the operating content is reflected.

Moreover, when the output mode is set, the change controller 30 is operated to output operating information sent from the remote controller 25 and received by the light-receiving module 26 to the AV apparatus 31 through the external connection terminal 30a. In this way, the controller 23 controls the external AV apparatus 31 by operating information sent from the remote controller 25.

When the output is set, the change controller 30 is further operated to output operating information output from an operating information generator 32 through the external connection terminal 30a based on the control of the controller 23 in accordance with the operation of the operating module 24 and the remote controller 25 by the user. In this way, the controller 23 controls the external AV apparatus 31 by operating information output from the operating information generator 32 built in the digital television broadcasting receiver 11.

In other words, the digital television broadcasting receiver 11 given as an AV apparatus is controlled by operating information sent from the remote controller 25 or by operating information supplied from other AV apparatus 31. Moreover, the digital television broadcasting receiver 11 given as an AV apparatus controls other AV apparatus 31 by operating information sent from the remote controller 25 or by operating information generated by the self.

As described above, the digital television broadcasting receiver 11 given as an AV apparatus can realize a transmission of operating information with other AV apparatus using various modes. This serves to achieve a diversification of operating mode, and thus, to perform easy handling for the user.

Moreover, the digital television broadcasting receiver 11 given as an AV apparatus has one external connection terminal 30a for making a connection with the external AV apparatus 31. The external connection terminal 30a is used for selectively changing to input and output of operating information. Therefore, this serves to simplify the configuration, and to effectively facilitate miniaturization.

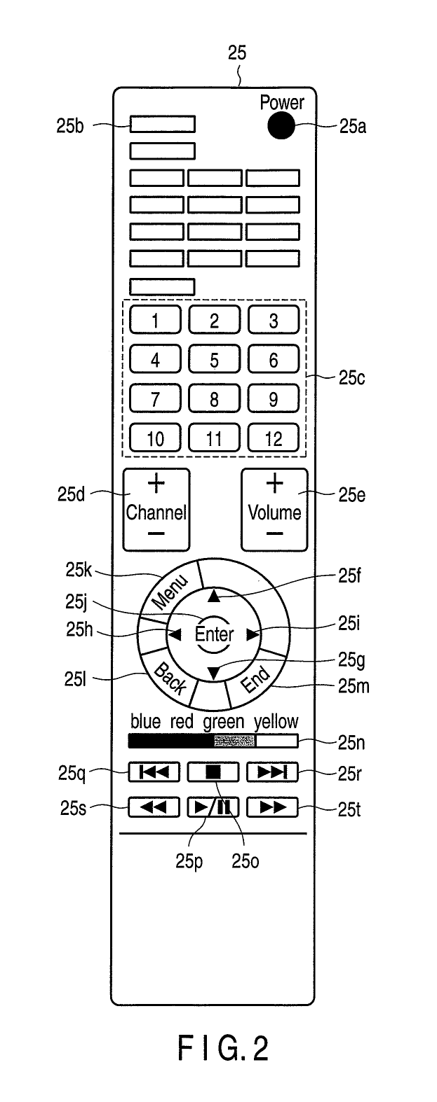

FIG. 2 shows the appearance of the foregoing remote controller 25. The remote controller 25 is mainly provided with a power key 25a, an input change key 25b, a numeral key 25c, a channel up-down key 25d, and a volume control key 25e. Further, the remote controller 25 is mainly provided with a cursor up key 25f, a cursor down key 25g, a cursor left key 25h, a cursor right key 25i, an enter key 25j, a menu key 25k, a back key 25l, an end key 25m, and four-color (blue, red, green, yellow) color key 25n.

Moreover, the remote controller 25 is provided with a play stop key 25o, a play/pause key 25p, a backward skip key 25q, a forward skip key 25r, a fast-forward key 25s and a fast-rewind key 25t.

Specifically, the user operates the play stop key 25o and the play/pause key 25p of the remote controller 25 with respect to information such as a video and audio acquired from the HDD 27, and thereby, play, stop and pause operation are carried out.

Moreover, the user operates the backward skip key 25q and the forward skip key 25r of the remote controller 25, and thereby, information such as a video and audio played by the HDD 27 is skipped by a predetermined amount in backward and forward directions to the play direction.

In addition, the user operates the fast-forward key 25s and a fast-rewind key 25t of the remote controller 25, and thereby, information such as a video and audio played by the HDD 27 is continuously played in backward and forward directions to the play direction. In this case, so-called fast-rewind and fast-forward reproduction are performed.

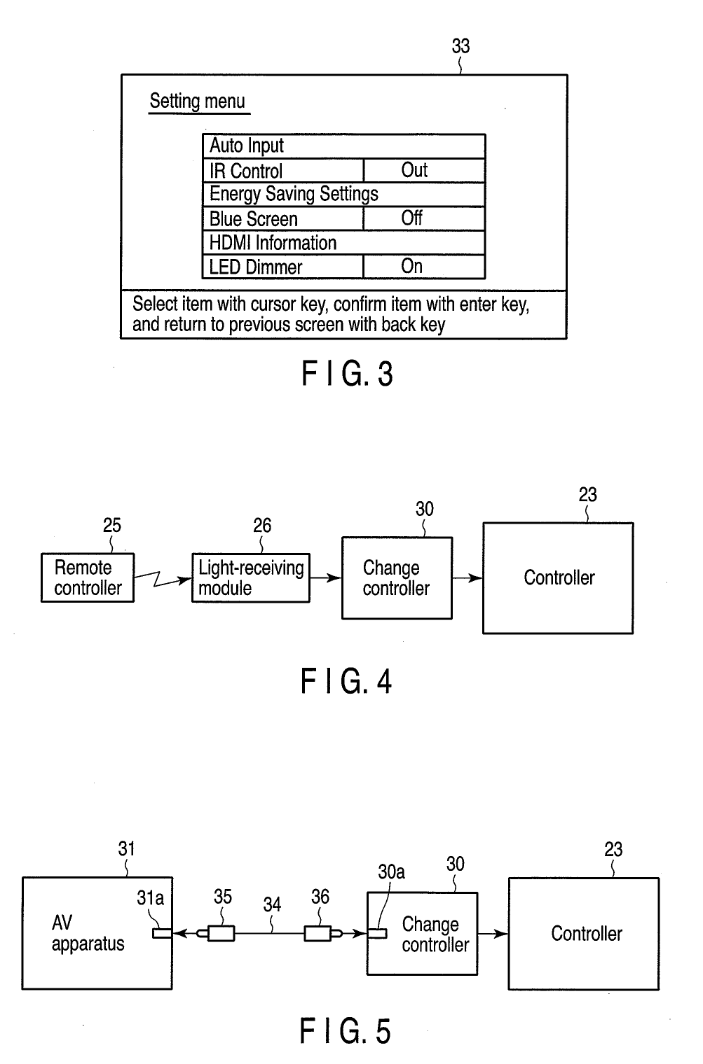

The operation of selectively changing the change controller 30 to input and output modes will be described below. According to this change operation, the user operates the menu key 25k of the remote controller 25 to display a plurality of menu screens having a hierarchy structure. In this case, a setting menu screen 33 shown in FIG. 3 is displayed on the video display module 21, and thereby, the change operation is carried out.

A plurality of the following items (six in FIG. 3) for setting various state of the digital television broadcasting receiver 11 is displayed on the setting menu screen 33. Specifically, there are displayed items such as “Auto Input”, “IR Control”, “Energy Saving Settings”, “Blue Screen”, “HDMI Information” and “LED Dimmer”. In this case, the user operates cursor up or down key 25f or 25g of the remote controller 25 to scroll displayed items to up or down direction, and thereby, a plurality of items other than the foregoing six items is displayable.

In a state that the setting menu screen 33 is displayed, the user operates cursor up or down key 25f or 25g of the remote controller 25 to select the item “IR Control”. In this state, when the user operates cursor left or right key 25h or 25i of the remote controller 25, “In” and “Out” are alternately changed with respect to the item “IR Control” every user operation.

In this case, the item “IR Control” is set to “In”, the change controller 30 is set to the input mode. Conversely, the item “IR Control” is set to “Out”, the change controller 30 is set to the output mode. Thus, the user sets the item “IR Control” to “In” or “Out”, and thereafter, operates the enter key 25j of the remote controller 25, and thereby, the change controller 30 is settable to the input or output mode.

The diversified transmission mode of operating information between the digital television broadcasting receiver 11 given as an AV apparatus and other AV apparatus 31 will be described below. FIG. 4 shows the flow of controlling the digital television broadcasting receiver 11 based on operating information sent from the remote controller 25.

Specifically, operating information sent from the remote controller 25 using infrared rays as a transmission medium by the user's operation is received by the light-receiving module 26 of the digital television broadcasting receiver 11, and then, converted into electrical operating information, and thereafter, supplied to the change controller 30. Even if the change controller is set to any cases of input and output modes, the operating information supplied from the light-receiving module 26 is supplied to the controller 23. In this way, the controller 23 receives the operating information sent from the rote controller 25 to controls the digital television broadcasting receiver 11.

FIG. 5 shows the flow of operating information of controlling the digital television broadcasting receiver 11 based on operating information output from other AV apparatus 31. Specifically, the AV apparatus 31 is provided with an output terminal 31a for externally outputting operating information. The output terminal 31a is connected to the external connection terminal 30a of the change controller 30 by means of a signal line 34.

In this case, both ends of the signal line 34 are attached with small jacks 35 and 36 having a size of about 3.5 mm, for example. The output terminal 31a of the AV apparatus 31 has a structure ton which one jack 35 is attached. The external connection terminal 30a of the change controller 30 has a structure to which the other jack 36 is attached. In this way, the AV apparatus 31 and the change controller 30 are connected by wire so that operating information is transmitted.

When being set to the input mode, the foregoing change controller 30 is operated to supply operating information supplied to the external connection terminal 30a to the controller 23 of the digital television broadcasting receiver 11. Therefore, the operating information output from the output terminal 31a of the AV apparatus 31 is supplied to the controller 23 through jack 34, signal line 34, jack 36, external connection terminal 30 and change controller 30. In this way, the controller 23 receives the operating information supplied from the AV apparatus 31 to control the digital television broadcasting receiver 11.

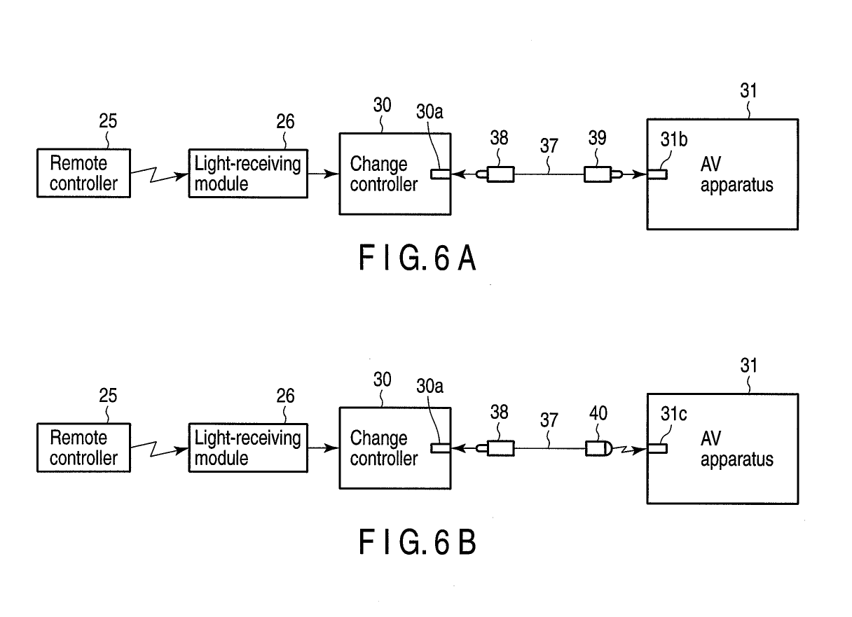

FIG. 6A shows the flow of operating information of controlling an AV apparatus 31 based on operating information sent from the remote controller 25. Specifically, the AV apparatus 31 is provided with an input terminal 31b for externally inputting operating information. The input terminal 31b is connected to the external connection terminal 30a of the change controller 30 by means of a signal line 37.

In this case, both ends of the signal line 37 are attached with small jacks 38 and 39 having a size of about 3.5 mm, for example. The input terminal 31b of the AV apparatus 31 has a structure ton which one jack 39 is attached. The external connection terminal 30a of the change controller 30 has a structure to which the other jack 38 is attached. In this way, the AV apparatus 31 and the change controller 30 are connected by wire so that operating information is transmitted.

When being set to the output mode, the foregoing change controller 30 is operated to output operating information supplied from the light-receiving module 26 to the controller 23 from the external connection terminal 30a. Therefore, the operating information sent from the remote controller 25 using infrared rays as a transmission medium is received by the light-receiving module 26 of the digital television broadcasting receiver 11, and then, converted into electrical operating information. Thereafter, the operating information is supplied to the AV apparatus 31 through change controller 30, external connection terminal 30a, jack 38, signal line 37, jack 39 and input terminal 31b of the AV apparatus 31. In this way, an external AV apparatus 31 is controllable by the operating information sent from the remote controller 25.

As shown in FIG. 6B, an AV apparatus 31 is provided with a light-receiving module 31c for receiving operating information using infrared rays as a medium in place of the input terminal 31b. In this case, a light-emitting module 40 having an electric/infrared conversion function is attached to one end of the signal line 37 in place of the jack 39 so that the module 40 is positioned near the light-receiving module 31c of the AV apparatus 31.

According to the foregoing configuration, operating information sent from the remote controller 25 is converted into electrical operating information by the light-receiving module 26 of the digital television broadcasting receiver 11. Thereafter, the converted operating information is supplied to the AV apparatus 31 through change controller 30, external connection terminal 30a, jack 38, signal line 37, light-emitting module 40 and light-receiving mole 31c of the AV apparatus 31. In this way, an external AV apparatus is controllable by the operating information sent from the remote controller 25.

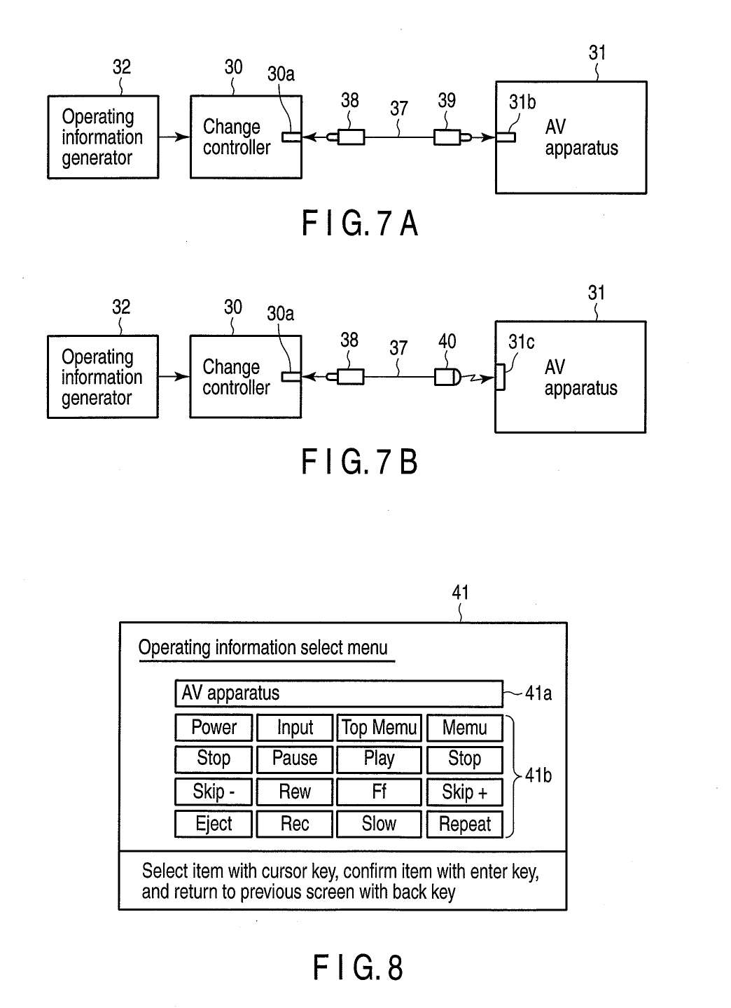

FIG. 7A shows the flow of operating information of controlling an AV apparatus 31 based on operating information output from the operating information generator 32 of the digital television broadcasting receiver 11. In FIG. 7A, the same numbers are used to designate potions identical to FIG. 6A. In this case, the change controller 30 is set to the output mode, and operating information supplied from the operating information generator 32 is output from the external connection terminal 30a.

Therefore, the operating information supplied from the operating information generator 32 is supplied to an AV apparatus 31 through change controller 30, external connection terminal 30a, jack 38, signal line 37, jack 39 and input terminal 31b of the AV apparatus 31. In this way, an external AV apparatus 31 is controllable by operating information sent from the digital television broadcasting receiver 11.

As shown in FIG. 7B, an AV apparatus 31 is provided with a light-receiving module 31c for receiving operating information using infrared rays as a medium in place of the input terminal 31b. In this case, a light-emitting module 40 having an electric/infrared conversion function is attached to one end of the signal line 37 in place of the jack 39 so that the module 40 is positioned near the light-receiving module 31c of the AV apparatus 31 like FIG. 6B.

In this way, operating information output from the operating information generator 32 is supplied to the AV apparatus 31 through change controller 30, external connection terminal 30a, jack 38, signal line 37, light-emitting module 40 and light-receiving mole 31c of the AV apparatus 31. Therefore, an external AV apparatus 31 is controllable by operating information sent from the digital television broadcasting receiver 11.

The operation of generating desired operating information for controlling an external AV apparatus 31 from the foregoing operating information generator 32 will be described below. According to the operation of generating operating information, the user operates the menu key 25k of the remote controller 25 to display a plurality of menu screens having a hierarchy structure. An operating information select menu screen 41 shown in FIG. 8 is displayed on a video display module 21.

The following items are displayed on the operating information select menu screen 41. One is an item 41a showing an AV apparatus, which is connected to the external connection terminal 30a of the change controller 30. The other is an item 41b showing a plurality of operating contents for controlling the AV apparatus 31. The user operates cursor up, down left and right keys 25f, 25g, 25h and 25i of the remote controller 25 to select a desired operating content from several items 41b, and then, operates the enter key 25j. In this way, the operating information corresponding to the selected operating content is output from the operating information generator 32.

If a plurality of AV apparatuses is serial-connected to the external connection terminal 30a, the user operates cursor up or down key 25f or 25g of the remote controller 25, each connected AV apparatus is successively displayed on the item 41a. In a state that a desired AV apparatus is displayed, when the user operates the enter key 25j of the remote controller 25, the AV apparatus is selected. In this case, an item 41b showing a plurality of operating contents for controlling the selected AV apparatus is displayed on the operating information select menu screen 41.

According to the foregoing embodiment, the digital television broadcasting receiver 11 given as an AV apparatus is controllable by operating information sent from the remote controller 25 or by operating information supplied from other AV apparatus 31. Moreover, the digital television broadcasting receiver 11 given as an AV apparatus can control other AV apparatus 31 by operating information sent from the remote controller 25 or by operating information generated by the self.

As described above, the digital television broadcasting receiver 11 given as an AV apparatus can realize a transmission of operating information with other AV apparatus 11 in various modes. Therefore, the diversification of operation modes can be achieved, and thus, this serves to perform easy handling for users.

Moreover, the digital television broadcasting receiver 11 given as an AV apparatus is provided with one external connection terminal 30a for making a connection with an external AV apparatus 31. The foregoing receiver 11 uses the external connection terminal 30a so that the terminal 30a is selectively changed to input and output the operating information. Therefore, this serves to simplify the configuration, and to effectively facilitate miniaturization.

According to the foregoing embodiment, the digital television broadcasting receiver 11 given as an AV apparatus receives the operating information for turning on the power by the light-receiving module. In this case, the possibility that the receiver 11 is operated using the remote controller 25 after that is high. Thus, the receiver 11 determines that the possibility of operating an external AV apparatus 31 by the self is high. Therefore, the receiver 11 automatically sets the change controller 30 to the output mode while the power is turned on.

Moreover, the digital television broadcasting receiver 11 given as an AV apparatus receives the operating information for turning on the power by the external connection terminal 30a. In this case, the receiver 11 determines that the possibility that the receiver 11 is operated by an external AV apparatus 31 after that is high. Therefore, the receiver 11 automatically sets the change controller 30 to the input mode while the power is turned on. This serves to further make easy the user's handling.

According to the foregoing embodiment, the remote controller 25 and the light-emitting module 40 send the operating information using infrared rays as a transmission medium. However, the present embodiment is not limited to above. For example, of course, lights other than an electromagnetic wave and infrared rays may be used as a transmission medium to wirelessly send the operating information.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a receiver configured to wirelessly receive a first command from a remote controller;
a connection terminal configured to input a second command over a wire when in an input state, and configured to output a third command over a wire;
a generator configured to generate the third command, wherein the third command comprises either the first command or the second command; and
a change module configured to switch the connection terminal between the input state and the output state.

2. The apparatus of claim 1, wherein the change module is further configured to switch the connection terminal between states via a displayed menu screen.

3. The apparatus of claim 1, wherein the change module is further configured to set the connection terminal to the output state when the receiver receives a power-on command, and to set the connection terminal to the input state when connection terminal receives a power-on command.

4. The apparatus of claim 1, wherein the generator is further configured to select a generated command on a displayed menu screen.

5. The apparatus of claim 1, wherein the connection terminal is further configured to attach to a first end of a signal line via a jack, and the signal line is configures to transmit a command.

6. The apparatus of claim 1, wherein the connection terminal is further configured to attach to the signal line via a 3.5 mm jack.

7. The apparatus of claim 5, wherein a second end of the signal line is configured to attach to a command output terminal of a second apparatus, or to a command input terminal of the second apparatus, via a second jack.

8. The apparatus of claim 5, wherein the second end of the signal line is configured to interface with a transmitter capable of wirelessly transmitting the third command.

9. A control method of an information processing apparatus, the method comprising:
wirelessly receiving, at a receiver, a first command from a remote controller;
inputting, at a connection terminal, a second command over a wire when the connection terminal is in an input state;
outputting, at the connection terminal, a third command over a wire when the connection terminal is in an output state, wherein the third command comprises either the first command or the second command;
generating, at a generator, the second command; and
switching the connection terminal between the input state and the output state.
